(19) United States
(12) Patent Application Publication
(10) Pub. No.: US 2026/0216970 A1
(43) Pub. Date: Jul. 30, 2026

(54) APPARATUS AND METHODS FOR FORMING COMPOSITE COMPONENTS

(71) Applicant: Short Brothers PLC, Antrim (GB)

(72) Inventors: Oran WALSH, Antrim (GB); Mark BRANIFF, Antrim (GB); Sam WILSON, Antrim (GB)

(21) Appl. No.: 19/139,782

(22) PCT Filed: Dec. 18, 2023
(86) PCT No.: PCT/GB2023/053283

§ 371 Date: Jun. 16, 2025

(30) Foreign Application Priority Data
Dec. 16, 2022 (GB) 2219112.6

(51) Int. Cl. B29C 70/44; B29C 70/54

(52) U.S. Cl. CPC B29C 70/443; B29C 70/548

(57) ABSTRACT

Herein is described a method of manufacturing a composite component (tool or part), wherein the method comprises: supplying resin (214) from a first port (220b) into a mould cavity (112); delaying supplying resin from a second port (220a, 220c) into the mould cavity until a resin front associated with the supply of resin from the first outlet reaches the second outlet; and supplying resin from the second outlet into the mould cavity once the resin associated with the supply of resin from the first outlet has reached the second outlet.

### TECHNICAL FIELD

Apparatus and methods for forming composite components. In particular, but not exclusively, the present disclosure relates to apparatus and methods for manufacturing composite parts, moulds or tools such as in the aerospace industry, that can be fabricated out of autoclave if desired.

### BACKGROUND OF THE INVENTION

In the manufacture of composite parts, such as body parts in the aerospace and other related industries, moulds are typically used for fabricating composite parts using a resin. The application of the resin typically takes place under highly controlled conditions, such as of temperature, pressure, etc. Conventionally, such composite parts are manufactured using Resin Transfer Moulding (RTM) with tooling in an autoclave. Accordingly, high-precision resin composite components can be fabricated.

A typical civil air transport wing consists of a main torsion box of ribs and spars with articulated control surfaces forming the trailing edge structure. This arrangement of control surfaces experiences considerable loads during certain critical flight phases. As a consequence these structures are complex in terms of stiffness/load introduction requirements and comprise intricate design features.

Autoclave manufacture is ideally suited for high-end, precision manufacture of parts, particularly where runs of larger volume, valuable components are required.

Out of Autoclave (OoA) manufacture is typically done where large components are required, which would not fit inside an autoclave. OoA manufacture gives the same quality output components as using an autoclave, however the process is different. OoA usually achieves this by placing a layup within a closed mould and applying vacuum, pressure, and heat.

It may be an object of one or more aspects, examples, embodiments, or claims of the present disclosure to at least mitigate or ameliorate one or more problems associated with the prior art, such as those described herein or elsewhere.

### SUMMARY OF THE INVENTION

According to an aspect there is provided a method of fabricating a composite component. The composite component may comprise a composite part; or a composite tool. The composite tool may be for subsequent use in the manufacture of a composite part. The method may comprise supplying resin from a plurality of ports or outlets. The ports or outlets may comprise resin inlets into a mould. The method may comprise supplying resin simultaneously from the plurality of ports. The method may comprise supplying resin from the plurality of ports simultaneously for at least a portion of a resin supply step/s. The method may comprise supplying resin from the plurality of ports simultaneously for only a portion/s of a resin supply step/s. The method may comprise initiating supply of resin from the plurality of ports or outlets sequentially.

In at least one example, there is provided a method of manufacturing a composite part, the method comprising:
supplying resin from a first outlet into a mould cavity;
delaying supplying resin from a second outlet into the mould cavity until a resin front associated with the supply of resin from the first outlet reaches the second outlet; and
supplying resin from the second outlet into the mould cavity once the resin associated with the supply of resin from the first outlet has reached the second outlet.

The method may comprise preventing or at least mitigating against a convergence of resin fronts. The method may comprise supplying resin from the plurality of ports or outlets without a resin front from each port or outlet meeting another resin front from another port or outlet. The method may comprise preventing or at least mitigating against a plurality of resin fronts from the plurality of ports or outlets. The method may comprise supplying a singular resin front/s from the plurality of ports or outlets. For example, the resin supplied from a plurality of ports or outlets may combine already at the outlet/s such that only a single resin front is propagated by the plurality of ports or outlets.

The method may comprise avoiding compressing a space or void between two resin fronts. The space or void may comprise a fluid, such as a gas (e.g. air). The method may comprise preventing, mitigating or at least reducing trapping, entrapping or entraining gas (e.g. air). The method may comprise avoiding or at least minimising trapping, entrapment or entraining gas in, with or adjacent the resin.

The method may comprise coordinating flows from the plurality of ports or outlets. The method may comprise synchronising flows from the plurality of ports or outlets. The method may comprise coordinating flows from the plurality of ports or outlets such that fronts from the plurality of ports or outlets are non-convergent. The method may comprise preventing convergence of two or more resin fronts.

The plurality of ports or outlets may comprise at least a first and a second port or outlet. The method may comprise supplying resin from the first outlet for a period of time prior to initiation of supply of resin from the second port or outlet.

The first port or outlet may be located centrally, such as more centrally, relative to the second port or outlet. The second port or outlet may be located closer to a periphery or exterior than the first port or outlet.

The method may comprise supplying resin such that fluid, typically air, present in the port or outlet and/or a supply conduit thereto, is dispelled. The method may comprise supplying resin such that fluid, typically air, present in the port or outlet and/or a supply conduit thereto, is dispelled by vacuum or suction away from the outlet and away from the mould cavity.

The method may comprise supplying resin to the port or outlets such that other fluid, such as air, present in the mould/cavity is expelled. The method may comprise supplying resin to the port or outlets such that other fluid, such as air, present in the mould/cavity is transported or directed towards the periphery or exterior of the mould.

The method may comprise providing each port or outlet with a controllable vacuum capability. For example, each port or outlet may be selectively connected and/or disconnected to a suction or vacuum source. Accordingly, each port or outlet may be selectively subjected to vacuum such that fluid (e.g. air) may be extracted from a port or outlet individually, controlled separately from another port or outlet.

The method may comprise monitoring passage of the resin. The method may comprise monitoring passage of the resin front/s. Additionally or alternatively, the method may comprise monitoring passage of the resin within a supply conduit/s.

The system may comprise a transparent, partially-transparent or at least translucent conduit/s, or at least portions thereof, such that the resin is visible in the conduit/s. The resin may be particularly visible where there is a boundary at the resin. For example, where resin is initially supplied, a boundary at the front of the resin may be visible between the resin and a fluid in front (e.g. air). The fluid in front of the resin may provide a visual contrast with the resin. The method may comprise activating vacuum/suction and/or supply of resin to each port in dependence on the monitoring of the resin, such as of the resin flow (e.g. from another port or outlet). The monitoring and/or selective control may be manual and/or automatic.

The method may comprise an out-of-autoclave method. The method may provide an alternative to fabrication in an autoclave.

As described herein, the hereby disclosed resin infusion technique may enable each resin line with vacuum capability. The provision of each resin line with vacuum capability may increase an effectiveness of vacuum and/or moisture extraction.

The injection may be sequenced to start in a middle of the part outwards towards the periphery. The method may comprise degassing air and/or volatiles from the resin and preform via the individual vacuum capability provided with each resin line.

Degassing air/volatiles from the resin & preform is extracted quickly by the next injection/vacuum line.

In another example, there is provided a method of manufacturing a composite component (tool or part), the method comprising: supplying resin from a first port into a mould cavity; delaying supplying resin from a second port into the mould cavity until a resin front associated with the supply of resin from the first outlet reaches the second outlet; and supplying resin from the second outlet into the mould cavity once the resin associated with the supply of resin from the first outlet has reached the second outlet.

The method may comprise preventing or at least mitigating against a convergence of resin fronts.

The method may comprise supplying resin from the plurality of ports or outlets without a resin front from each port or outlet meeting another resin front from another port or outlet.

The method may comprise supplying the resin front as a singular resin front from the plurality of ports or outlets.

The method may comprise combining the resin from the first and second outlets already at the second outlet such that only a single resin front is propagated by the plurality of ports or outlets.

The method may comprise only supplying the resin from the second outlet into the cavity once or after the resin from the first outlet reaches or passes the second outlet.

The method may comprise supplying the resin into the second outlet to purge or dispel a gas, such as air, from the second outlet, the gas being dispelled from the second outlet prior to the resin from the first outlet reaching the second outlet.

The method may comprise avoiding compressing a space or void between two resin fronts, thereby preventing, or at least reducing, trapping, entrapping or entraining gas.

The method may comprise supplying resin to the outlets such that the gas present in the mould cavity is transported or directed towards a periphery or exterior of the mould.

The method may comprise synchronising flows from the plurality of outlets such that fronts from the plurality of outlets are non-convergent.

The method may comprise supplying resin from the first outlet for a period of time prior to initiation of supply of resin from the second outlet.

The first outlet may be located more centrally (equidistant from edges) relative to the second outlet, with the second outlet being located equidistant or closer to a periphery or exterior than the first outlet.

The method may comprise a resin transfer injection method for manufacturing, the method comprising: fitting a preform assembly, comprising the mould fashioned to define a shape of the product; allowing the preform assembly to reach at least a predefined temperature; defining the cavity with the preform assembly; establishing at least a partial vacuum in the cavity; injecting a volume of pressurised or unpressurised preheated resin into the cavity; using injection pressure of the resin and/or the at least partial vacuum to move the resin throughout the cavity; and start infusion of the resin into the product preform of the preform assembly; allowing the resin infused into the product preform to cure to form the composite component (tool or part).

The method may comprise providing each port with a controllable vacuum capability.

Each outlet may be selectively connected and/or disconnected to a suction or vacuum source, such that each outlet is selectively subjected to vacuum whereby fluid, such as air, is extracted from each outlet individually, the extraction being controlled separately from another outlet.

The method may comprise monitoring passage of the resin.

Monitoring the passage of the resin may comprise monitoring passage of the resin front/s.

The method may comprise monitoring passage of the resin within a supply conduit/s.

At least a portion of the supply conduit/s may comprises a transparent, partially-transparent or at least translucent conduit/s, such that the resin is visible in the conduit/s and/or cavity.

The method may comprise activating for each outlet, in dependence on the monitoring of the resin, one or more of: vacuum; suction and/or supply of resin.

The method may comprise vacuum only infusion without applying additional pressure, such as to the mould. The method may alternatively use additional pressure.

The method may comprise an out-of-autoclave method. The method may also be used within an autoclave.

The method may comprises vacuum only infusion at 120° C. (or ranging from 30 -120 C) ; and curing out of autoclave at 180° C. (ranging from 50 C-205 C-including post-cure).

The method may comprises a fabrication of a one-piece Out-of-Autoclave cocured coinjected stiffened aircraft torque box with integral laminar flow enabling leading edge to be formed accurately.

In another example, there is provided a manufacturing apparatus, the manufacturing apparatus comprising: a mould with a mould cavity, wherein the mould comprises at least a first and a second outlet, each outlet being for supplying resin into the mould cavity; a control system, the control system being configured to delay supplying resin from the second outlet into the mould cavity until a resin front associated with the supply of resin from the first outlet reaches the second outlet; and a resin supply system, the resin supply system being configured to supply resin from the second outlet into the mould cavity in dependence on the control system, such that resin is supplied from the second outlet once the resin associated with the supply of resin from the first outlet has reached the second outlet.

In another example, there is provided a method of manufacturing a composite component, the method comprising: defining a first mould line with at least one rebate or pocket along a leading edge; providing an oversized insert in the rebate or pocket; curing the oversized insert in situ in the rebate or pocket, thereby ensuring at least one surface of the insert is match-moulded.

The method may also comprise providing a planar split plane for a non-linear highlight.

The planar split lane may define a datum surface for setting a bonded backing structure.

The method may comprise providing a plurality of openings at or along the leading edge.

The plurality of openings may provide for connection to the component/preform for one or more of: resin injection and/or air extraction.

The match-moulded surface of the oversized insert may not be machined.

At least two surfaces of the oversized insert may be match-moulded.

An exposed surface/s of the insert may be machined to profile.

The cured composite parts may be used in aerospace construction such as for wing or fuselage parts. The method may be utilised for the fabrication of aerostructures. The aerostructures may be primarily flight control surfaces. For example, the composite parts may comprise one or more of: Small UAV parts; wings; Flaps; Ailerons; H Stabs/V Stabs etc. The formed composite part may be in the form of an extended longitudinal structure.

According to an aspect there is provided a system comprising the apparatus of any other aspect, example, embodiment or claim. The apparatus may comprise the substructure or a component thereof, such as a support/skirt element, of any other aspect, claims, embodiment or example.

According to an aspect, there is provided a method of using the apparatus, such as the mould and/or resin injection system or portion/s thereof, according to an aspect, claim, embodiment or example of this disclosure.

The steps of the method may be in any order.

According to an aspect of, there is provided an apparatus configured to perform a method according to an aspect, claim, embodiment or example of this disclosure.

Within the scope of this disclosure it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

Embodiments of the disclosure will now be described, by way of example only, with reference to the appended pages.

It will be clear to those of skill in the art that the above-and below-described embodiments are merely exemplary, and that various modifications and improvements thereto may be made without departing from the embodiments described. For example, the tooling and the component may be a range of shapes and sizes. The tooling and the component may also be made a range of suitable materials. Likewise, where methods are performed out of autoclave, such as to save on costs, the methods may also be applicable to in-autoclave fabrication-such as where similar benefits may also be achieved.

It will be appreciated that embodiments of the present invention can be realised in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape. It will be appreciated that the storage devices and storage media are embodiments of machine-readable storage that are suitable for storing a program or programs that, when executed, implement embodiments of the present invention. Accordingly, embodiments provide a program comprising code for implementing a system or method as disclosed in any aspect, example, claim or embodiment of this disclosure, and a machine-readable storage storing such a program. Still further, embodiments of the present disclosure may be conveyed electronically via any medium such as a communication signal carried over a wired or wireless connection and embodiments suitably encompass the same.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed. The claims should not be construed to cover merely the foregoing embodiments, but also any embodiments which fall within the scope of the claims, including with equivalence as appropriate.

Illustrative examples are appended in the following pages.

### BRIEF DESCRIPTION OF THE DRAWINGS

Embodiments of the present invention will now be described, by way of example only, with reference to the following figures:

FIG. 1a illustrates a typical VARTM (Vacuum Assisted Resin Transfer Moulding) technique and associated apparatus according to the prior art;

FIG. 1b illustrates another typical VARTM (Vacuum Assisted Resin Transfer Moulding) technique and associated apparatus according to the prior art;

FIG. 2a illustrates an elevation view of an embodiment of a VARTM technique and apparatus according to the present invention;

FIG. 2b Illustrates a Plan View of the Embodiment of FIG. 2a;

FIG. 3a illustrates an elevation view of an example first step in the process of the moulding process using the embodiment in FIGS. 2a and 2b;

FIG. 3b Illustrates a Plan View of the Embodiment of FIG. 3a;

FIG. 4a illustrates an elevation view of an example second step in the process of the moulding process using the embodiment in FIGS. 2a and 2b;

FIG. 4b Illustrates a Plan View of the Embodiment of FIG. 4a;

FIG. 5a illustrates an elevation view of an example third/final step in the process of the moulding process using the embodiment in FIGS. 2a and 2b;

FIG. 5b illustrates a plan view of the embodiment of FIG. 5a;

FIG. 6 illustrates an example method flowchart of the present invention;

FIG. 7 illustrates embodiments of an OML (Outer Mould Line) tool;

FIG. 8 illustrates carbon tooling features from the OML (Outer Mould Line) tool;

FIG. 9 illustrates example control surfaces which comprises non-linear profiles; and

FIG. 10 illustrates an example of an oversized insert for manufacturing an OML.

### DETAILED DESCRIPTION OF THE DRAWINGS

In a typical OoA resin infusion method, dry carbon non-crimp fabric (NCF) is formed/deposited on a master mould to create a preform. Resin infusion consumables are strategically placed to enable infusion of the resin and adequate air/volatile extraction. Consumables may be for example Peel ply, flow mesh, and omega tubes.

A nylon bag is then placed over the mould to create a vacuum tight chamber. Resin/vacuum feed lines are brought through the nylon vacuum bag. The dry fibre is then resin infused in an oven i.e. out of autoclave.

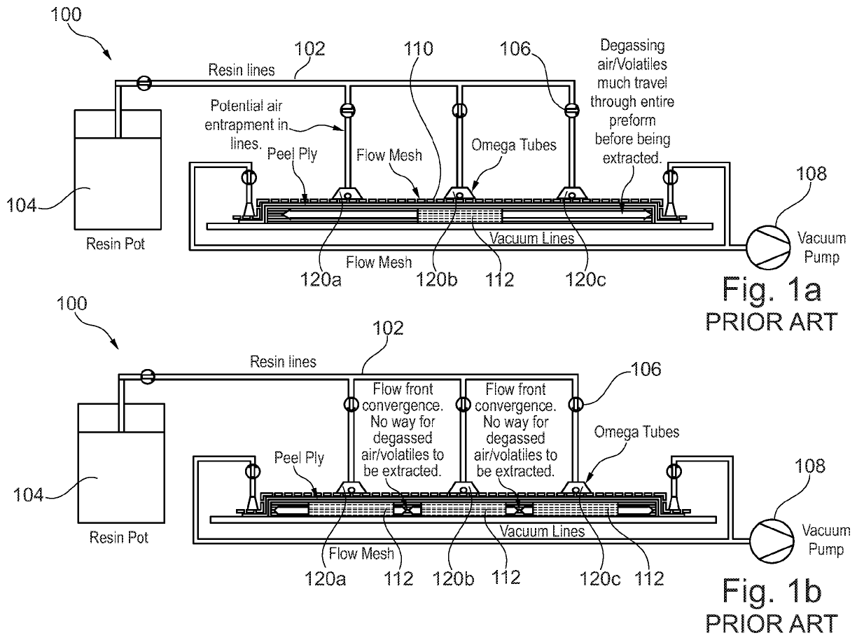

Two typical VARTM (Vacuum Assisted Resin Transfer Moulding) techniques according to the prior art will be described in reference to FIGS. 1a and 1b. The general method is to draw vacuum only around part periphery and injection via resin distribution media (Omega tubes). This can be done in two ways, one of which is shown in FIG. 1a, and one of which is shown in FIG. 1b.

FIG. 1a illustrates a typical VARTM technique and associated apparatus 100 according to the prior art. The apparatus 100 comprises a resin pot 104 which is distributed to the mould via resin lines 102. In this particular embodiment, the resin lines 102 split into three channels. The three channels are connected to the mould via omega tubes 120a, b, c. Each omega tube comprises an on/off valve 106, which allows or prevents resin/air from passing through.

Also shown is a vacuum pump 108 which is connected to both sides of the mould. In use, the vacuum pump 108 provides a suction force to both ends of the mould to draw out the air and resin. The flow mesh 110 of the mould lay-up is also shown. The flow mesh 110 is to ensure the rapid spread of the infusion resin, and to enable the efficient removal of air by the vacuum pump.

In FIG. 1a, a first method according to the prior art is shown, where infusion is conducted via the central omega tube 120b. This is done by opening the valve 106 on the central omega tube 120b, whilst keeping the other two valves 106 shut. As the resin 112 enters the preform via the centre omega tube 120b, air and other volatile gasses from the resin flow must travel across and through the entire preform before being extracted by the vacuum lines at the ends of the preform/mould. Furthermore, air will accumulate in the empty resin lines (i.e. the outer injection lines) and will then be re-injected once the line opens. This is not desirable for achieving high quality mouldings.

FIG. 1b illustrates another typical VARTM (Vacuum Assisted Resin Transfer Moulding) technique and associated apparatus 100 according to the prior art. In this example, resin infusion is conducted through all resin lines and omega tubes 120a, b, c simultaneously. This is done by opening all three omega tube valves 106, thus permitting the resin to flow through them.

This results in convergence of resin flow 112 fronts, and increases the likelihood of porosity/dryness as the degassing air cannot be extracted. As shown in FIG. 1b, there are two internal compression convergence points, in which air cannot escape. Once the air is compressed in these areas, the air will leak out through the resin, causing distortions and bubbling. This is obviously not desirable for high quality resin moulding. Improvement is therefore desirable.

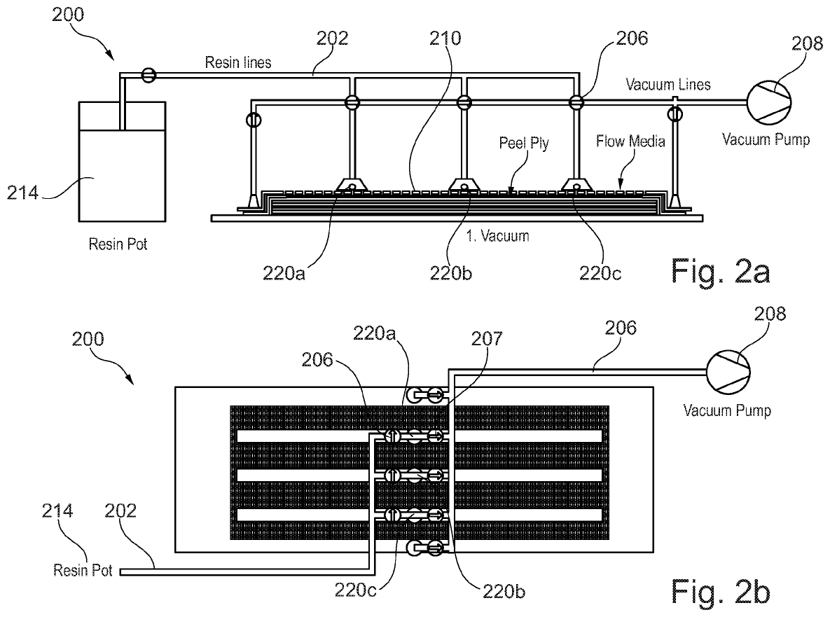

One embodiment of an apparatus and technique according to the invention will now be described, in relation to FIGS. 2-5.

FIG. 2a illustrates an elevation view of an embodiment of a VARTM technique and apparatus 200 according to the present invention and FIG. 2b illustrates a plan view of the embodiment of FIG. 2a. The apparatus 200 and technique enables each resin line 202 to have vacuum capability, as well as a resin injection capability, with the view to increasing the effectiveness of vacuum/moisture extraction.

FIGS. 2a and 2b show a resin pot 214, resin lines 202 leading to the omega tubes 220a, b, c. Each omega tube has a resin valve 206 and a vacuum valve 207. The flow mesh 210 is shown within the layup of the mould. As in FIGS. 1a and 1b, there is a vacuum bag over the whole mould/preform which prevents the air and resin from escaping, and creates an air-tight seal for the vacuum system to work effectively.

As easily seen in FIG. 2b, all three of the resin valves 206 are closed, and the three vacuum valves 207 are open. This is the configuration the apparatus 200 is in before resin injection starts.

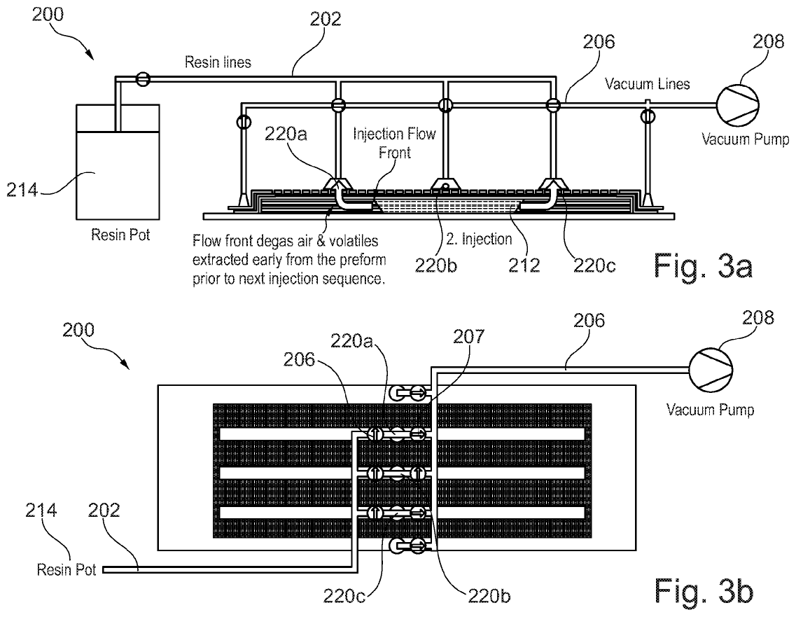

FIG. 3a illustrates an elevation view of an example first step in the process of the moulding process using the embodiment in FIGS. 2a and 2b, and FIG. 3b illustrates a plan view of the embodiment of FIG. 3a.

The injection sequence is started in the middle omega tube 220b, by opening the middle resin valve 206 and closing the middle vacuum valve 207. This permits the resin to flow out of the middle omega tube 220b and into the preform. The remaining resin valves 206 remain closed, and the outer vacuum valves 207 remain open. This is to allow the outer omega tubes 220a, c to remain functioning as vacuums.

The resin 212 can be seen flowing from the middle of the mould to the outsides clearly in FIG. 3a. This technique allows for the flow front (ahead of the resin 212 injection) to be extracted early via the adjacent vacuum lines. This prevents any build up of resin, and prevents any air pockets from forming. The flow front referred to is the portion which is just ahead of the resin 212 in the resin's direction of travel. There may be two flow fronts, one either side of the resin 212, if the resin is extending in both directions. There may only be one flow front, if the resin is only flowing in one direction.

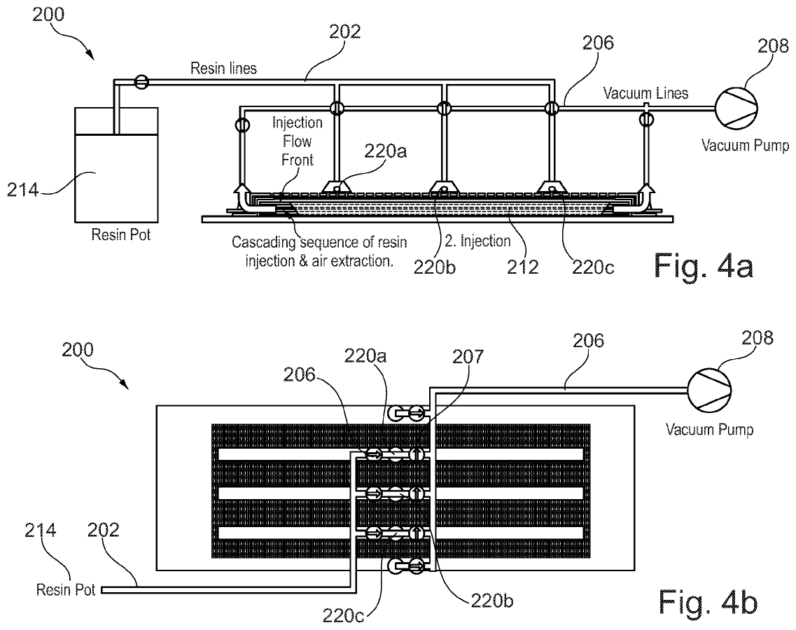

Once the resin 212 has reached a predetermined distance from the middle omega tube 220b, the apparatus moves onto the next injection sequence shown in FIGS. 4a and 4b.

FIG. 4a illustrates an elevation view of an example second step in the process of the moulding process using the embodiment in FIGS. 2a and 2b, and FIG. 4b illustrates a plan view of the embodiment of FIG. 4a.

Once the resin 212 reaches the next injection line (the outer lines 220a and 220c), the vacuum valves 207 are closed and the resin valves 206 are opened on the outer two lines. This permits resin to flow from all three omega tubes 220a, b, c and into the preform. The outer two lines which previously had air/volatile gasses in them are now expelled of gasses as the resin is inserted. The resin 212 continues to progress along the preform to the outer edges, the two external vacuum lines extract the remaining air and volatile gasses.

It should be stressed that there are no limits to the number of injection/extraction lines within the system. The embodiment shown is merely for example purposes only. The process described is particularly suitable for large tools and moulds where proper air evacuation is critical.

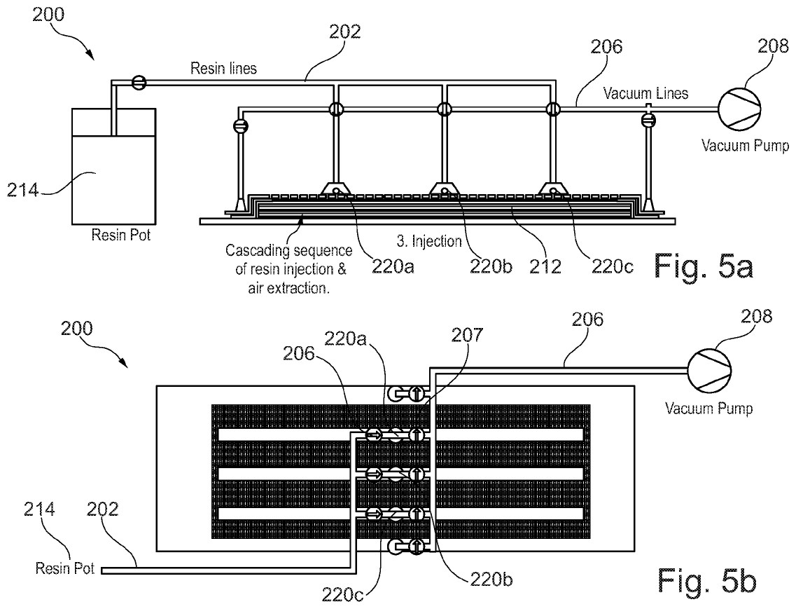

FIG. 5a illustrates an elevation view of an example third/final step in the process of the moulding process using the embodiment in FIGS. 2a and 2b and FIG. 5b illustrates a plan view of the embodiment of FIG. 5a.

FIGS. 5a and 5b show the end of the process, i.e. when the cavity is full of resin 212. All valves 206/207 are closed and the component progresses to cure.

The above illustrated process shows a novel and efficient way to mould resin in an out of autoclave process. The series of valves 206/207 and the omega tubes 220 a, b, c, function in combination to allow for efficient pouring of the resin 212 and extraction of the gasses via the vacuum pump.

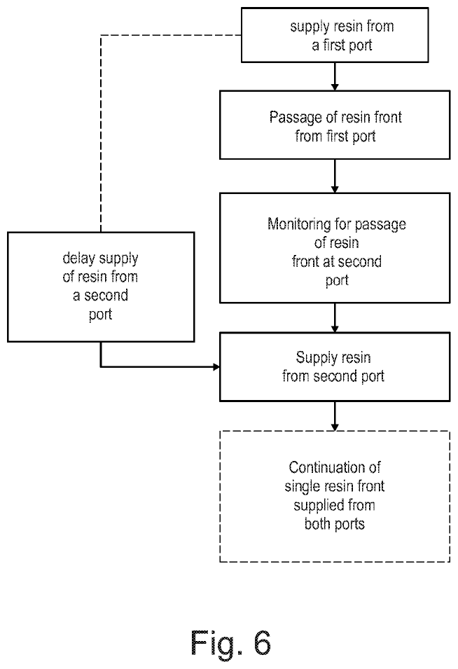

FIG. 6 illustrates an example method of the present invention. In one embodiment, there is a method described which supplies resin from a first port into the preform. Resin then passes out of the first port into the preform, and along the preform to the remaining exits. There is then active monitoring for the passage of resin at a second port. There is a delay of supply at the second port, however once the resin reaches the second port, supply is initiated from the second port. The method then continues to supply resin from both ports, thus forming a single resin front which travels along the preform.

The described method may be used at multiple ports along the preform, with the method being repeated each time. For example, there may be a third port, where the process starts again. The resin may be supplied from the first and second ports, whilst the resin supply from the third port is delayed. Once the resin front reaches the third port, the supply of resin from the third port is initiated.

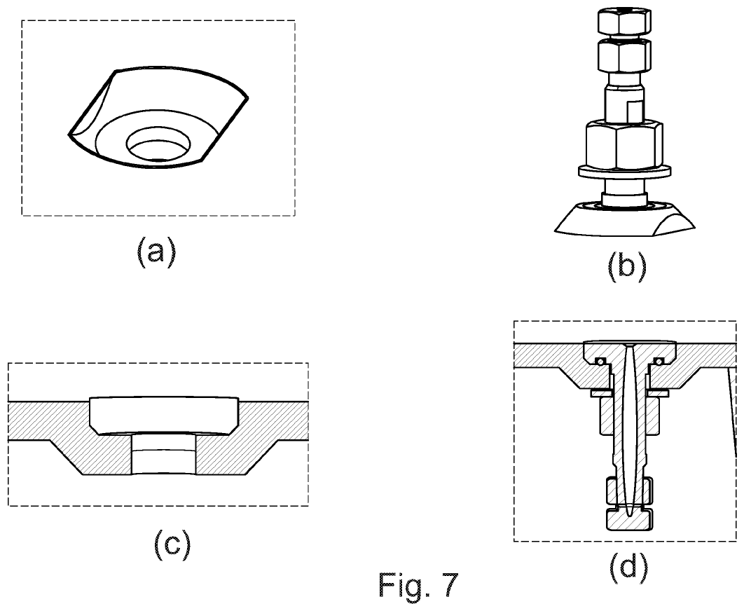

FIG. 7 illustrates embodiments of an OML (Outer Mould Line) tool. FIG. 7a shows a moulded pocket, FIG. 7b shows a custom/bespoke vacuum port, FIG. 7c shows a moulded pocket cross section, and FIG. 7d shows the port installed within the moulded pocket.

This custom tool is required to enable resin injection and air extraction from the component through the OML mould tool, since injection ports and vacuum ports are required.

The pocket feature shown in 7a is net moulded into the carbon OML tool. A bespoke metallic port (shown in FIG. 7b) was created to fit the rebated pocket providing vacuum integrity. The port also comprises a clamping nut, flattened sides to prohibit the port from spinning or turning when installed, and standard BSP connections for connecting to copper pipework.

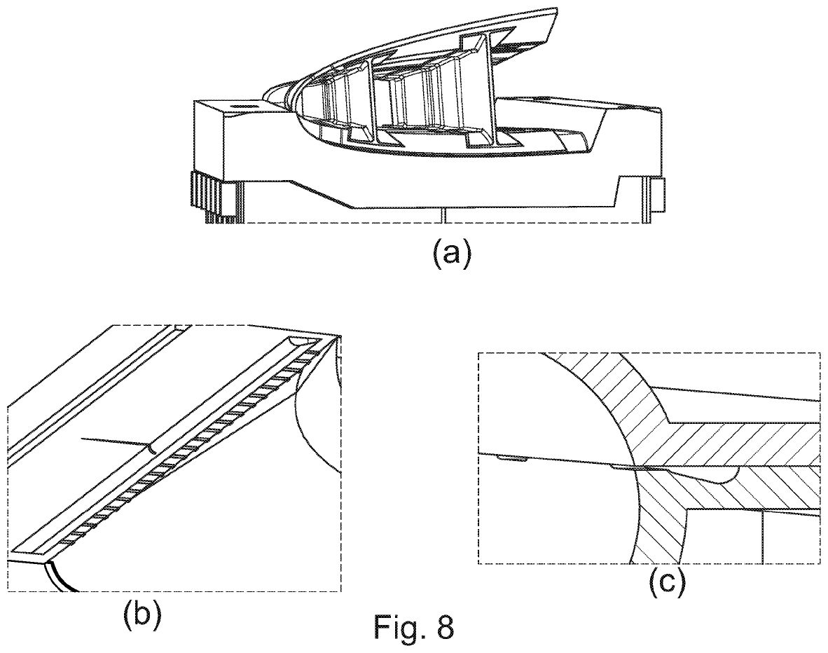

FIG. 8 illustrates carbon tooling features from the OML (Outer Mould Line) tool. To manufacture a one-piece torque box (which may be required) two OML mould tools (upper and lower) are required to come together to create the aerodynamic surface for an aerofoil/wing section. The mating surfaces of the mould at the leading edge (shown in FIG. 8a) must be as seamless as possible to avoid any irregularities known as ‘mark off’.

However, to aid resin infusion and air extraction, a method to create a link to the component was required, whilst minimising potential mark-off/witness lines. This was done via a pattern of small (around 0.5″ to 0.02″) slots, which were introduced into the lower OML (shown in FIG. 8b) mould along the leading edge of the wing. When mated with the upper OML tool, a series of very small openings allows a connection between the component/preform to facilitate resin injection and or air extraction (shown in FIG. 8c).

This is an important feature used in moulding large wing components in this configuration. Leading edge slots allow the resin to fully enter and set in/at the leading edge. Without the slots, bulging can occur. Furthermore, porosity within the leading edge can also be an issue.

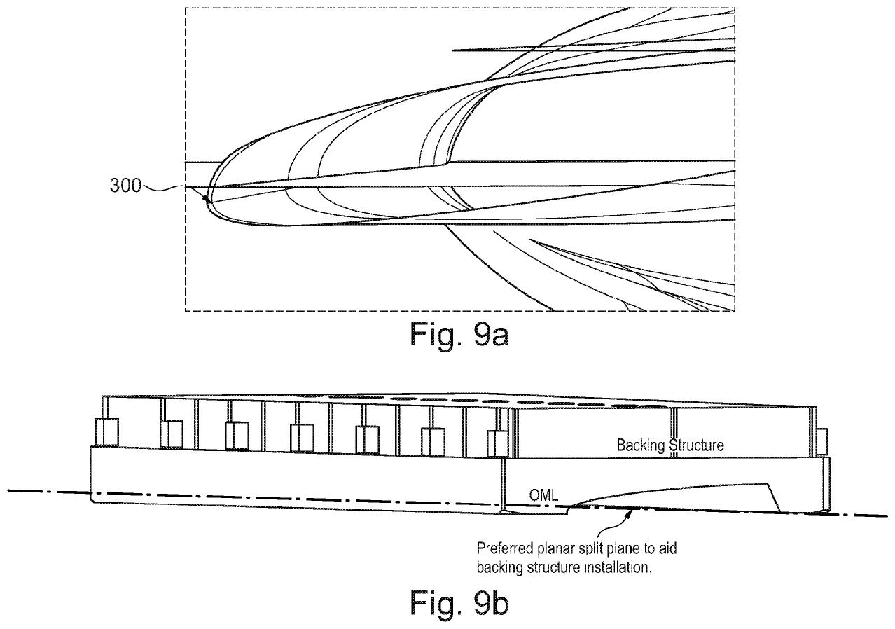

FIGS. 9a and 9b illustrate example control surfaces which comprises non-linear profiles. These components have a non-linear highlight (twist), which causes added difficultly when trying to determine an optimum split plane to separate the closed mould.

The addition of twist or a non-linear highlight means a proportion of the component will be situated ‘deeper’ in one mould vs the other. If a single planar surface is used to separate the two moulds, a ‘lock in’ feature is created which would effectively trap the component in the mould. An example lock-in feature 300 is shown in FIG. 9a. this is clearly not desirable, as it would prevent manufacture of the component.

To avoid such inaccuracies and mismatch issues, a planar split plane is the preferred approach as opposed to variable split plane which would follow the highlight. Additionally, a planar split plane offers the ideal datum surface in which to use to set a bonded backing structure (see FIG. 9b).

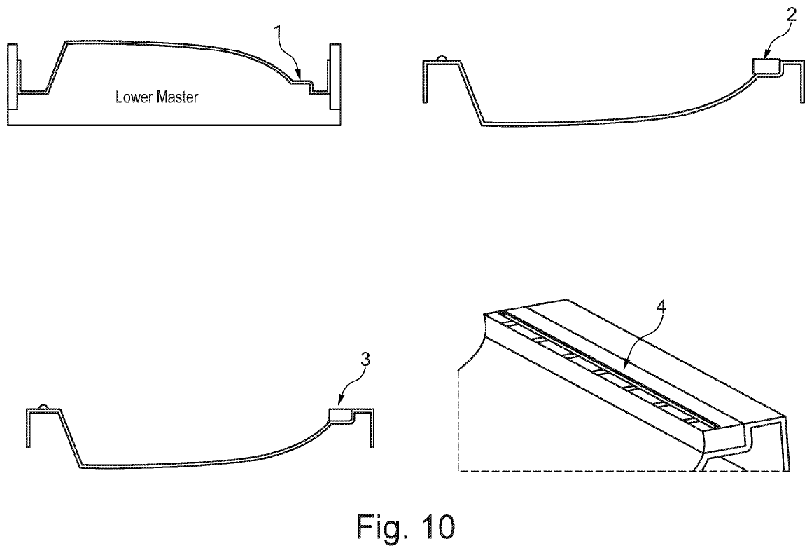

FIG. 10 illustrates an example of an oversized insert for manufacturing an OML.

In order to maintain a planar split plane with a non-linear highlight, a solution has been developed. To achieve this, as shown by ref 1 in FIG. 10, a lower OML is created with a rebate/pocket along the leading edge.

Ref 2 shows an oversized insert, which has been manufactured from either carbon fibre prepeg or resin infused, is cured in-situ in the rebate. This ensures two of the four surfaces of the insert are perfectly match moulded, and thus do not require further machining.

Ref 3 shows the remaining two exposed surfaces, which are machined to profile. The profile in contact with the component will feature entirely or partially an undercut surface. The insert is located and fixed to the OML by plastic shear pins. As this lock-in feature is incorporated into the insert and not the OML mould, the insert can be removed along with the component during demoulding.

Ref 4 shows the insert with machined bespoke resin feed channels.

The oversized insert effectively allows for components with a large twist to be manufactured successfully, and completely avoids the issue of ‘lock-in’ as described above.

1. A method of manufacturing a composite component (tool or part), the method comprising:
supplying resin from a first port into a mould cavity;
delaying supplying resin from a second port into the mould cavity until a resin front associated with the supply of resin from the first outlet reaches the second outlet; and
supplying resin from the second outlet into the mould cavity once the resin associated with the supply of resin from the first outlet has reached the second outlet.

2. The method of manufacturing of claim 1, wherein the method comprises one or more of:
preventing or at least mitigating against a convergence of resin fronts;
supplying the resin front as a singular resin front from the plurality of ports or outlets;
supplying resin from the plurality of ports or outlets without a resin front from each port or outlet meeting another resin front from another port or outlet.

3. (canceled)

4. (canceled)

5. The method of manufacturing of claim 1, wherein the method comprises supplying the resin front as a singular resin front from the plurality of ports or outlets;
the supplying the resin front as a singular resin front comprising combining the resin from the first and second outlets already at the second outlet such that only a single resin front is propagated by the plurality of ports or outlets.

6. The method of manufacturing of claim 5, wherein, the method comprises only supplying the resin from the second outlet into the cavity once or after the resin from the first outlet reaches or passes the second outlet.

7. The method of manufacturing of claim 5, wherein, the method comprises supplying the resin into the second outlet to purge and/or dispel a gas, such as air, from the second outlet, the gas being dispelled from the second outlet prior to the resin from the first outlet reaching the second outlet.

8. The method of manufacturing of claim 7, wherein the method comprises avoiding compressing a space or void between two resin fronts, thereby preventing, or at least reducing, trapping, entrapping or entraining gas.

9. The method of manufacturing of claim 7, wherein the method comprises supplying resin to the outlets such that the gas present in the mould cavity is transported or directed towards a periphery or exterior of the mould.

10. The method of manufacturing of claim 1, wherein the method comprises synchronising flows from the plurality of outlets such that fronts from the plurality of outlets are non-convergent.

11. The method of manufacturing of claim 1, wherein the method comprises supplying resin from the first outlet for a period of time prior to initiation of supply of resin from the second outlet.

12. (canceled)

13. The method of manufacturing of claim 1, wherein the method comprises a resin transfer injection method for manufacturing, the method comprising:
fitting a preform assembly, comprising the mould fashioned to define a shape of the product;
allowing the preform assembly to reach at least a predefined temperature;
defining the cavity with the preform assembly;
establishing at least a partial vacuum in the cavity;
injecting a volume of pressurised or unpressurised preheated resin into the cavity;
using injection pressure of the resin and/or the at least partial vacuum to move the resin throughout the cavity; and start infusion of the resin into the product preform of the preform assembly;
allowing the resin infused into the product preform to cure to form the composite component (tool or part).

14. The method of manufacturing of claim 1, wherein the method comprises providing each port with a controllable vacuum capability.

15. The method of manufacturing of claim 1, wherein each outlet is selectively connected and/or disconnected to a suction or vacuum source, such that each outlet is selectively subjected to vacuum whereby fluid, such as air, is extracted from each outlet individually, the extraction being controlled separately from another outlet.

16. The method of manufacturing of claim 1, wherein the method comprises monitoring passage of the resin.

17. (canceled)

18. The method of manufacturing of claim 16, wherein the method comprises monitoring passage of the resin within a supply conduit/s.

19. The method of manufacturing of claim 18, wherein at least a portion of the supply conduit/s comprises a transparent, partially-transparent or at least translucent conduit/s, such that the resin is visible in the conduit/s and/or cavity.

20. The method of manufacturing of claim 1, wherein the method comprises activating for each outlet, in dependence on the monitoring of the resin, one or more of: vacuum; suction and/or supply of resin.

21. The method of manufacturing of claim 1, wherein the method comprises vacuum only infusion without applying additional pressure, such as to the mould.

22. The method of manufacturing of claim 1, wherein the method comprises an out-of-autoclave method.

23. The of manufacturing of claim 22, wherein the method comprises vacuum only infusion at 120° C.; and curing out of autoclave at 180° C.

24. (canceled)

25. A manufacturing apparatus, the manufacturing apparatus comprising:
a mould with a mould cavity, wherein the mould comprises at least a first and a second outlet, each outlet being for supplying resin into the mould cavity;
a control system, the control system being configured to delay supplying resin from the second outlet into the mould cavity until a resin front associated with the supply of resin from the first outlet reaches the second outlet; and
a resin supply system, the resin supply system being configured to supply resin from the second outlet into the mould cavity in dependence on the control system, such that resin is supplied from the second outlet once the resin associated with the supply of resin from the first outlet has reached the second outlet.
